(19) United States
(12) Patent Application Publication
(10) Pub. No.: US 2026/0051706 A1
(43) Pub. Date: Feb. 19, 2026

(54) POWER EXTENSION CORDS

(71) Applicants: Sahil Mehta, Leander, TX (US); Kuntal Mehta, Leander, TX (US)

(72) Inventors: Sahil Mehta, Leander, TX (US); Kuntal Mehta, Leander, TX (US)

(21) Appl. No.: 19/298,814

(22) Filed: Aug. 13, 2025

Related U.S. Application Data
(60) Provisional application No. 63/682,665, filed on Aug. 13, 2024.

(51) Int. Cl. H01R 13/72

(52) U.S. Cl. CPC H01R 13/72

(57) ABSTRACT

An extension cord includes at least one plug, at least one socket, and a winding means placed within an enclosure. The enclosure has a flap that is reversibly opened or closed to provide access to the plugs and/or the sockets. The winding means allows for a cord connecting the plugs and the sockets to be coiled thereover and allows the cord to be extended from the enclosure when pulled. A biasing means biases the winding means to retract and wind the cord when not in use. The extension cord provides a portable and adjustable length solution for extending power reach, while also providing a tangle-resistant and self-organizing design.

### CROSS-REFERENCE TO RELATED APPLICATIONS

The present application is based upon and claims the right of priority to U.S. Provisional Ser. No. 63/682,665 , filed Aug. 13, 2024, the disclosure of which is hereby incorporated by reference herein in its entirety for all purposes.

### TECHNICAL FIELD

The present disclosure relates generally to extension cords, and in particular to portable power extension cords with extendable sockets.

### BACKGROUND OF THE PRESENT DISCLOSURE

Extension cords are commonly used devices intended for temporarily extending the reach of an outlet to hazardous or hard to reach areas in a variety of environments, both domestic and industrial. These cords typically include components such as electrical cable loaded with conductors, along with plug and connector bodies at the ends of the cable.

Existing extension cords present certain technical problems. For example, existing extension cords often have a fixed length, i.e., they cannot be adjusted on demand to fit specific situations, which results in either unneeded extra cord length causing clutter and trip hazards, or a shortage of length causing inconvenience. In addition, cords with large lengths are susceptible to easily getting tangled, making the cords difficult to manage and potentially increasing the risk of damage to the electrical connections of the extension cord and/or short-circuits. Furthermore, many of the current designs lack any automatic means to organize the wires, and users have to arrange the wires manually, which can be a tedious and a time-consuming task.

Therefore, there is a need for an extension cord that alleviates at least the aforementioned problems.

### SUMMARY

Aspects of the present disclosure are directed to an extension cord that includes at least one plug, at least one socket, and a winding means placed within an enclosure. The enclosure has a flap that is reversibly opened or closed to provide access to the plugs and/or the sockets. The winding means allows for the cord to be wound thereover, while allowing the cord connecting the plugs and the sockets to be unwound and extended from the enclosure when pulled. A biasing means biases the winding means to wind the cord when not in use. The extension cord provides a portable and an adjustable length solution for extending power reach, while also providing a tangle-resistant and self-organizing design.

Various objects, features, aspects and advantages of the subject matter will become more apparent from the following detailed description of preferred embodiments, along with the accompanying drawing figures in which like numerals represent like components

### BRIEF DESCRIPTION OF THE ACCOMPANYING DRAWINGS

The accompanying drawings illustrate carrying out the disclosure as instantly contemplated and set forth hereinafter. The present disclosure may be more clearly understood from a consideration of the following detailed description of the preferred embodiments taken in conjunction with the accompanying drawings where figures are diagrammatic and not to scale. Further, for reference, the letters and numbers indicate the corresponding parts in various figures in the accompanying drawings.

FIG. 1A illustrates a representation of an example extension cord with a flap thereof in a closed position, according to embodiments of the present disclosure.

FIGS. 1B and 1C illustrate representations of an example extension cord with a flap in an open position, according to embodiments of the present disclosure.

FIG. 1D illustrates a perspective view of an example extension cord plugged to a wall outlet, according to embodiments of the present disclosure.

FIGS. 2A and 2B illustrate block diagram representations of an example extension cord, according to embodiments of the present disclosure.

### DETAILED DESCRIPTION

In the following description, for the purposes of explanation, various specific details are set forth in order to provide a thorough understanding of embodiments of the present disclosure. It will be apparent, however, that embodiments of the present disclosure may be practiced without these specific details. Several features described hereafter can each be used independently of one another or with any combination of other features. An individual feature may not address all of the intent discussed above or might address only some of the intents discussed above. Some of the intents discussed above may not be fully addressed by any one or number of features described herein.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various revisions may be made in the function and arrangement of elements without departing from the scope of the present disclosure as set forth.

The word “exemplary” and/or “demonstrative” is used herein to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other features, aspects or designs, nor is it meant to preclude other structures and/or techniques known to those of ordinary skill in the art.

Reference throughout this specification to “some embodiments” or “other embodiments” or “one embodiment” or “an embodiment” or “an instance” or “one instance” means that a particular feature, structure, or characteristic described in connection with the embodiment is included in at least one embodiment of the present disclosure. Thus, the appearances of the phrases “in some embodiments,” “in one embodiment,” or “in an embodiment” in various places throughout this specification are not necessarily all referring to the same embodiment. Furthermore, the particular features, structures, or characteristics may be combined in any suitable manner in one or more embodiments.

The terminology used herein is for the purpose of describing particular embodiments only and is not intended to be limiting of the present disclosure or embodiment. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Furthermore, to the extent that the terms “includes,” “has,” “contains,” and other similar words are used in either the detailed description or the claims, such terms are intended to be inclusive—in a manner similar to the term “comprising” as an open transition word.

As used herein, “substantially” means largely or considerably, but not necessarily wholly, that is sufficient to work for the intended purpose. The term “substantially” thus allows for minor, insignificant variations from an absolute or perfect state, dimension, measurement, result, or the like, as would be expected by a person of ordinary skill in the art, but that do not appreciably affect overall performance.

As used herein, “about” means approximately or nearly and in the context of a numerical value or range set forth means ±20% of the numeric value.

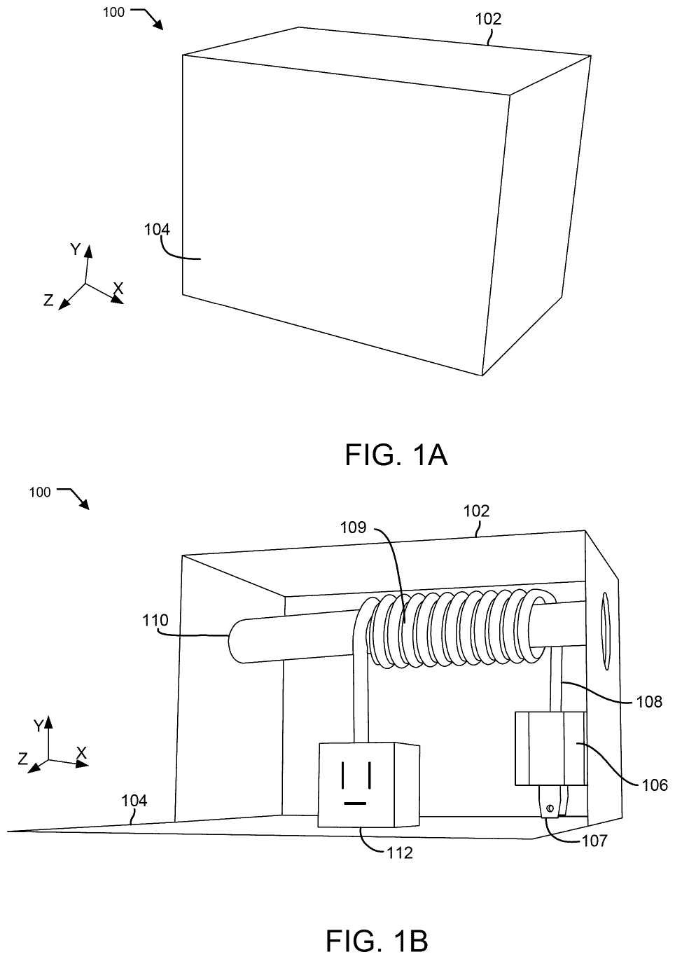

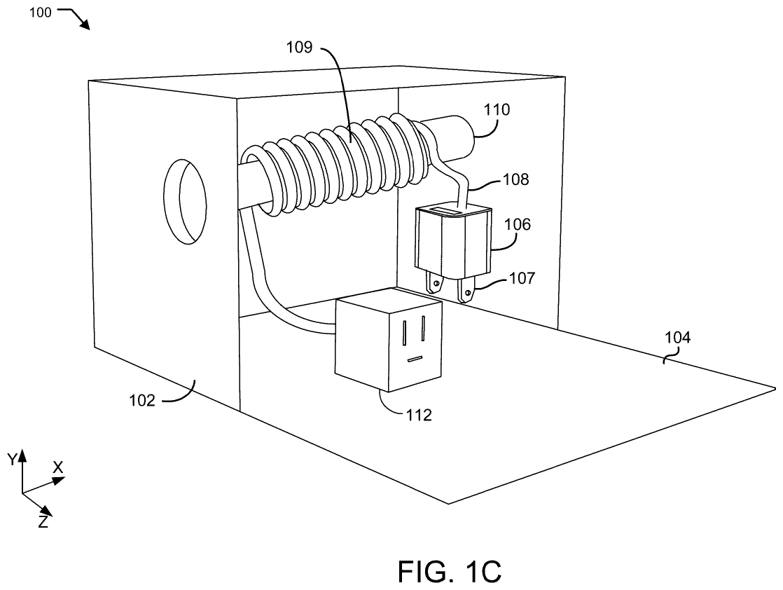

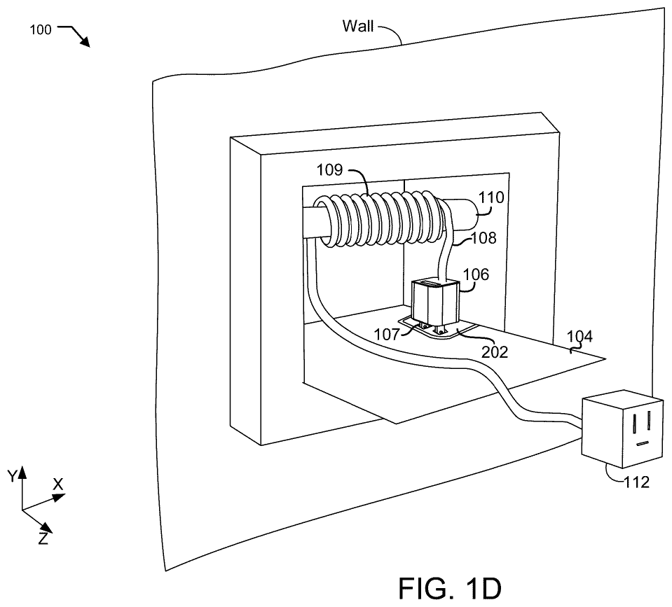

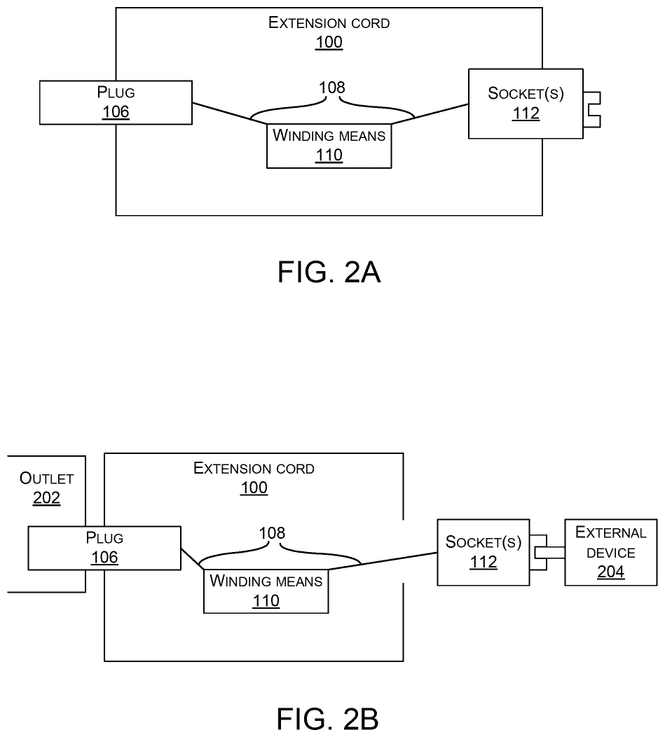

Various embodiments of the present disclosure are described in detail in reference to FIGS. 1A to 2B.

FIG. 1A illustrates a representation of an extension cord 100 in a closed position, and FIGS. 1B and 1C illustrate representations of the extension cord 100 in an open position, according to embodiments of the present disclosure. FIG. 1D illustrates a perspective view of an example extension cord plugged to a wall outlet, according to embodiments of the present disclosure. Further, FIGS. 2A and 2B illustrate block diagram representations of the extension cord, according to embodiments of the present disclosure.

As shown, the extension cord 100 may include an enclosure 102 having a flap 104. The flap 104 may be opened or closed to provide access to other components of the extension cord 100. In some embodiments, the enclosure 102 may be substantially cuboidal in shape. In such embodiments, the flap 104 may be defined on one side of the enclosure 102. In other embodiments, the enclosure 102 may have any other shape, with the flap 104 being defined on any straight or curved side of the enclosure 102.

In some embodiments, the flap 104 may be moveable between the open position and the closed position. In some embodiments, the flap 104 may be attached to the enclosure 102 using a hinge that allows the flap 104 to be pivoted/rotated between the open and the closed positions. In other embodiments, the flap 104 may be a slide-in flap, which may be mounted on sidetracks. The slide-in flap may slide between the open and the closed positions by moving along the sidetracks defined on the enclosure 102. In further embodiments, the flap 104 may be made of resilient material. In such embodiments, the flap 104 may be pushed or pulled to bend and/or contour the flap 104 to the open position, and thereafter released such that the flap 104 returns to the closed position due to its natural resilience or stiffness. In yet other embodiments, the flap 104 may slip on or off the enclosure 102 as and when necessary.

In some embodiments, the flap 104 may be retained in either the closed position or the open position. In some embodiments, the flap 104 may include a retention means (not shown) configured to retain the flap 104 at either the open or the closed positions. The retention means may include, but not be limited to, a latch, hook-and-loop fasteners, hook-and-slot fasteners, a pair of magnets, or the like. The retention means may be disposed on opposing surfaces of the enclosure 102 and the flap 104. The retention means may be brought into contact, thereby maintaining the flap 102 in the closed position or the open position. The retention means may be provided on any surface of the enclosure 102 and the flap 104 located substantially along the edge of the flap 104. For example, in the slide-in flap, opposing surfaces of the enclosure 102 and the flap 104 may include ledges acting as the retention means. In another example where the flap 104 may be attached to the enclosure 102 via a hinge, the opposing surfaces where the hinge is present may include slots/pockets and/or pins functioning as the retention means. In yet another example, at least one of the opposing surfaces of the enclosure 102 and the flap 104 may include hook-and-loop fastener that retain the flap 104 in either the open or the closed positions. In further examples, the enclosure 102 and the flap 104 may include corresponding hook-and-slot fasteners that engage with each other to retain the position of the flap 104.

In some embodiments, the enclosure 102 and the flap 104 may be made of electrically insulated materials. In some embodiments, the enclosure 102 and the flap 104 may be made of any one or a combination of plastic, rubber, fabric, silicone, fiberglass, wood, and the like. Using electrically insulated materials may insulate users from electrical shocks when the extension cord 100 is in use.

In other embodiments, the enclosure 102 may not include the flap 104, and plugs 106 and/or sockets 112 of the extension cord 100 may protrude out from the enclosure 102, as shown in FIG. 1D. The plugs 106 and the sockets 112 may protrude such that they are accessible to users of the extension cord 100.

In some embodiments, the extension cord 100 may include at least one plug 106. The plug 106 may include one or more contact members 107. In some embodiments, the plug 106 may include at least two contact members 107 for each current carrying connection of an (wall) outlet 202, as shown in FIG. 1D. The outlet 202 may be power outlets connected to a power grid, or wirings of inverters, batteries, or other power sources. The plug 106 may include other contact members 107, such as an earth ground connection for safety, for example.

In some embodiments, the contact member 107 in the plug 106 may be either male connectors or female connectors, or a combination thereof. The contact members 107 may be any or a combination of pins, jacks, blades, holes, or slots used as terminals to be engaged by complementary terminals of an electrical outlet, such as outlet 202. The outlet 202 may include one or more corresponding pins, and/or slots or receptacles that engage with the contact members 107 to form electrical connections. In some embodiments, the plug 106 and/or the contact members 107 may be made of electrically conducting materials. In some embodiments, the plug 106 and/or the contact members 107 may be made of one or a combination of copper, aluminum, nickel-chromium alloys, or the like.

In some embodiments, the plug 106 may be coupled to the enclosure 102, such as fixedly attached thereto. In other embodiments, the plug 106 may be removably attached to the enclosure 102. In such embodiments, the plug 106 may be suitably replaced with another plug having a different set of contact members 107. In some embodiments, the plug 106 may be attachable to an adapter to allow the extension cord 100 to be connected to any type/standard of the outlet 202.

The contact members 107 may be electrically connected to an electrical wiring/cord 108 of the extension cord 100. In some embodiments, the cord 108 may be electric wires. In some embodiments, the electric wires may be 12-gauge wires, but not be limited thereto. While embodiments of the present disclosure are described in the context of the cord 108 being electric wires, it may be appreciated by those skilled in the art that the cord 108 may be any other cable, such as fiber optic cables, coaxial cables, Ethernet, audio and/or video cables, phone extension cables, and the like. In some embodiments, the cord 108 may be housed within a sheath. The sheath may be any suitable material, such as an electrically insulating material, a flexible material, a durable material, or the like. In some embodiments, the sheath may be made of any one or a combination of plastic, rubber, fabric, or the like.

The cord 108 may be configured with the plug 106 on a first end and the socket 112 on a second end thereof. The cord 108 may electrically connect the plug 106 and the socket 112, thereby allowing electric power to be supplied to external device(s) 204 connected to the extension cord 100 through the socket 112. The length of the cord 108 may be determined based on requirements, dimensions of the enclosure 102, and the like.

In some embodiments, the socket 112 may be receptacles or outlets that allow other devices, such as the external device 204 shown in FIGS. 2A and 2B, to be electrically connected to the extension cord 100. The socket 112 may allow the external device 204 to be connected thereto through a corresponding device plug. The external device 204 may be any of, but not limited to, smartphones, laptops, tablets, hardware appliances, and the like. In some embodiments, the socket 112 may be of a type complementary to that of the plug 106. In other embodiments, the sockets 112 and the plug 106 may be of different types, thereby allowing the extension cord 100 to be used as an adapter. The plug 106 and the socket 112 may comply with standards prescribed in various jurisdictions. In some embodiments, the sockets 112 and the plug 106 may be defined on opposite sides or adjacent sides of the enclosure 102.

In some embodiments, the extension cord 100 may include a winding means 110. In some embodiments, the winding means 110 may be configured to wind the cord 108 thereover into a coil 109. In such embodiments, the winding means 110 may include a cylindrical element rotatably configured in the enclosure 102, over which the cord 108 may be coiled/wound. In some embodiments, when the socket 112 is pulled or extended outward, the cord 108 may unwind from the winding means 110 and allow the socket 112 to be extended out of the enclosure 102. In some embodiments, rotating the winding means 110 in a first direction may wind the cord 108 into the coil 109, and rotating the winding means 110 in a second direction may unwind the cord 108. In some embodiments, the plug 106 and the socket 112 may be connected to the winding means 110 such that the plug 106 and the socket 112 rotate independently with respect to each other. In such embodiments, the plug 106 and the socket 112 may not be connected directly through the cord 108, but through an electrical connection means that allows for independent rotation of the plug 106 and the socket 112.

In other embodiments, the winding means 110 may be a spiral cord or a curly cord. The spiral cord may allow the cord 108 to be extended in length when stretched, such as by straightening. The spiral cord may be biased to return to a spiral or a curly orientation when released. In some embodiments, the winding means 110 may be configured to control the length of the cord 108 and/or the socket 112. In some embodiments, the winding means 110 may include a mechanism that allows the user to manually adjust the length of the cord 108 or the socket 112. In such embodiments, the mechanism may include a rotary knob, a lever, a push button, or the like, that wind the cord 108 over one or more rotatable elements of the winding means 110.

In some embodiments, the winding means 110 may include a biasing means that biases the winding means 110 to wind the cord 108 over the cylindrical element. In such embodiments, the biasing means may be a coil spring attached to the cylindrical element. In other embodiments, the cord 108 may be made of a material that has a natural tendency to coil or spiral. In such embodiments, the cord 108 may be wind by the winding means 110 without the need for an additional biasing means.

The winding means 110 may allow the socket 112 to be extended out from the extension cord 100/enclosure 102. The socket 112 may be pulled away from the enclosure 102 against the bias of the biasing means, thereby causing the winding means 110 to unwind and release the cord 108. The socket 112 may be positioned in any desired position, and connected to the external device 204, through the device plug of the external device 204. Further, when the socket 112 is no longer required, the socket 112 may be disconnected from the external device 204. In such examples, the biasing means may cause the cord 108 to be pulled and wound over the winding means 110, thereby pulling/retracting the socket 112 towards the enclosure 102.

In some embodiments, the winding means 110 may include one or more guides (not shown) that direct the cord 108 to be wound onto the winding means 110 in an organized manner, to reduce the risk of tangling the cord 108. The guides may be defined on the enclosure 102. For example, the guide may be configured to prevent the cord 108 from crossing over itself while being wound onto the winding means 110. In some embodiments, the guides may be defined in the shape of tracks, hooks, holes, slots, and the like, that straighten loops, for example, on the cord 108.

In some embodiments, the extension cord 100 may include a switch (not shown) corresponding to the socket 112. In some embodiments, the switch may be configured to protrude out from the enclosure 102 to be accessible to the users. The electrical circuits of the switch may be defined within the enclosure 102. The switch may be configured to allow the user to turn the extension cord 100 on or off. The switch may include one or more buttons, levers, or sliders that are connected to the electrical circuit of the extension cord 100.

The extension cord 100 may further include other components, such as, but not limited to, an indicator light (not shown). The indicator light may be used to visually indicate whether the extension cord 100 is turned on or off. In some embodiments, the indicator light may illuminate when the extension cord 100 is powered on. The indicator light may be a Light Emitting Diode (LED) or any other type of indicator light, which may be configured to be visible to the user. The indicator light may be positioned within the enclosure 102, on the flap 104, on the plug 106, or on the socket 112.

In some embodiments, the extension cord 100 may be configured to include a set of electrical safety equipment. For example, the extension cord 100 may include an electric fuse (not shown). The electric fuse may be configured to protect the external device 204 from short-circuits, overcurrent conditions, and the like.

While embodiments of the present disclosure are described in the context of the extension cord 100 having one socket 112, it may be appreciated by those skilled in the art that the extension cord 100 may be suitably adapted to include more than one socket 112. In such embodiments, the plug 106 may be configured to supply electric power to multiple sockets 112 in parallel. Further, the extension cord 100 may include corresponding cords 108, winding means 110, switches, and other components for each of the sockets 112. Each of the sockets 112 may be configured to be extendable from different directions/sides of the enclosure 102. In some embodiments, size and dimensions of the enclosure 102 may be determined based on requirements, such as number of plugs 106, number of sockets 112, length of the cord 108, winding means 110 used, and the like.

FIGS. 2A and 2B illustrate block diagrams for the use of the extension cord 100 of the present disclosure. As shown, when not in use, the plug 106 and the socket 112 may be held within the enclosure 102. When a need arises for using the extension cord 100, the extension cord 100 may be carried to the nearest power source, such as the wall outlet 202 connected to the power grid. In some embodiments where the plug 106 protrudes out from the enclosure 102, the plug 106 may be connected to the outlet 202 directly. In embodiments where the plug 106 is placed within the enclosure 102, the flap 104 may be opened, and the plug 106 may be pulled out of the enclosure 102 and connected to the outlet 202.

Once connected to the outlet 202, the user may extend the socket 112 by pulling the socket 112 away from the enclosure 102. The cord 108 may unwind from the winding means 110 as the socket 112 is extended, allowing the user to position the socket 112 in a convenient location away from the enclosure 102 for connecting the external device 204. The external device 204 may be connected to the socket 112 using the corresponding device plug.

After the external device 204 is connected, the user may switch on the extension cord 100, and use the extension cord 100 to supply power to the external device 204. The extension cord 100 may allow the user to conveniently extend the reach of the power source to the external device 204 located in hard-to-reach areas.

When the external device 204 is no longer needed or when the user wants to store the extension cord 100, the socket 112 may be disconnected from the external device 204. The winding means 110 may automatically rewind the cord 108 as the socket 112 is retracted into the enclosure 102. The flap 104 may be closed, securing the plug 106 and the socket 112 within the enclosure 102. The guides may prevent the cord 108 from tangling as the winding means 110 retracts/winds the cord 108, thereby providing a compact, portable, and self-organizing extension cord 100.

The extension cord 100 disclosed herein addresses at least some of the problems associated with existing extension cords. The portable and adjustable length features of the extension cord 100 allow for flexibility and convenience in various scenarios. The winding means 110 and self-organizing features eliminate the need to manually arrange and untangle the cords 108. The extension cord 100 provides a reliable and efficient solution for extending power reach in a safe and organized manner. Further, having a flap 104 that provides access to all components of the extension cord 100 allows for easier maintenance, and convenient repair and/or replacement of parts. For example, if any of the plug 106, the cord 108, the coil 109, and/or the socket 112 is damage or needs replacement, the user of the extension cord 100 may open the flap 104 to obtain access to the aforementioned components, and disassemble and/or replace said components from the extension cord 100.

Although the disclosure has been shown and described with respect to one or more implementations, equivalent alterations and modifications will occur to others skilled in the art based upon a reading and understanding of this specification and the annexed drawings. The disclosure attempts to include such modifications and alterations. In particular regard to the various functions performed by the above-described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure.

The skilled person will be aware of a range of possible modifications of the various embodiments described above.

1. An extension cord, comprising:
at least one plug;
at least one socket;
an enclosure;
a winding placed within the enclosure, the enclosure has a flap that is reversibly opened or closed to provide access to the at least one plugs and/or the at least one socket; and
a biasing means biases the winding means to retract and wind the cord when not in use.
